(19) United States
(12) Patent Application Publication
(10) Pub. No.: US 2012/0171631 A1
(43) Pub. Date: Jul. 5, 2012

(54) Cologne and Perfume Candle System

(76) Inventor: Sherman Patterson, Appomattex, VA (US)

(21) Appl. No.: 12/984,769

(22) Filed: Jan. 5, 2011

(51) Int. Cl. F23D 3/02; B23P 11/00

(52) U.S. Cl. 431/320; 29/428

(57) ABSTRACT

A scented candle, and a method of creating the same, comprising: a jar; a scented oil, where said scented oil is stored in the jar; a wick, where the wick rests within the scented oil; and a cologne, where said cologne is infused in the scented oil. The jar may include a lid to seal the oil and wick when not in use. The jar may also include a handle and a label for communicating the type of cologne infused in the scented oil.

### BACKGROUND OF THE INVENTION

1. Field of Invention

The present invention relates to a cologne and perfume candle system that provides an aromatic fragrance.

2. Description of Related Art

A candle typically includes a solid block was with an embedded wick. Candles have been used for centuries and were initially used for illumination or as a heat source for many years. Due to the advent of electricity, candles are presently used for aesthetic purposes, aromatherapy, romantic ambiance, emergency lighting and religious ceremonies. The candle wick is ignited with a match or lighter and burns to emit light, heat and/or fragrance in some instances. Although candles are made of wax, some candles include a liquid burning substance. Candles may be produced to include various colors, shapes, sizes and scents. Fragrance oils are added to scented candles to provide aromatic enjoyment of the burning candle. Some candles include essential oils such as musk, saddlewood and jojoba to provide special aromas and scents associated with the burning of a candle. It would be advantageous to have a candle burning system or device that utilizes many of the popular cologne or perfume scents that are normally worn by individual.

### SUMMARY OF THE INVENTION

The present invention relates to a scented candle, and a method of creating the same, comprising: a jar; a scented oil, where said scented oil is stored in the jar; a wick, where the wick rests within the scented oil; and a cologne, where said cologne is infused in the scented oil. The jar may include a lid to seal the oil and wick when not in use. The jar may also include a handle and a label for communicating the type of cologne infused in the scented oil.

### BRIEF DESCRIPTION OF DRAWINGS

FIG. 1 depicts a scented candle system according to a present invention.

### DETAILED DESCRIPTION

The present invention provides a scented fragrance infused candle burning system that implements the use of popular colognes and perfume scents. The present invention provides an aromatic infused liquid or oil that includes the popular scents of many colognes and perfumes.

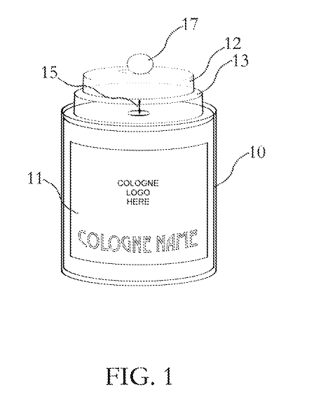

FIG. 1 depicts a scented candle jar 10 according to the present invention. The candle jar 10 includes a wick 15 that extends from an opening 13. The candle jar 10 according to the present invention includes scented oil that is scented with a popular cologne or perfume fragrance. Many cologne fragrances may provide a suitable scent for the present invention such as some of the men's designer fragrances by Ralph Lauren, Armani, Hugo Boss or Versace. Further exemplary scented fragrances may also include women's fragrances such as Liz Claiborne, Ralph Lauren, Calvin Klein or Burberry to name a few. The candle jar 10 includes a label 11 and a lid 12 with handle 17. As contemplated by the present invention, the lid 12 is removed and the wick 15 is ignited to burn and emit the desired fragrance into the atmosphere. The lid 12 seals the opening 13 while the candle is being stored. The label 11 depicts the cologne name or logo that may be associated with the scent provided by the candle jar 10.

The candle jar 10 provides a fragrance infused candle that may be provided in an 18-ounce size. The oil within the candle jar is infused with the popular desired cologne or perfume scent and therefore the scent is emitted into the atmosphere near and surrounding the burning candle. The inclusion of popular cologne or perfume provides a unique design for aromatherapy and overall enhancement of the atmosphere near the candle. The present invention also takes advantage of the popularity of the known colognes and scents that are used by individuals and allows the use of a scent as oil in a candle.

What is claimed is:

1. A scented candle comprising:
a. a jar;
b. a scented oil, where said scented oil is stored in the jar;
c. a wick, where the wick rests within the scented oil; and
d. a cologne, where said cologne is infused in the scented oil.

2. The scented candle according to claim 1, where said jar includes a lid to seal the oil and wick when not in use.

3. The scented candle according to claim 1, where said jar includes a handle.

4. The scented candle according to claim 1, where said jar includes a label for communicating the type of cologne infused in the scented oil.

5. A method of creating a scented candle comprising the steps of:
a. placing a scented oil in a jar;
b. infusing a cologne into the scented oil; and
c. placing a wick into the scented oil.

6. The method of claim 5 further providing a lid to the seal the oil and wick when not in use.
